(19) United States
(12) Patent Application Publication
(10) Pub. No.: US 2014/0140488 A1
(43) Pub. Date: May 22, 2014

(54) SYSTEM AND METHOD FOR PROVIDING CONTINUED ANSWERING OF SPECIAL NUMBER CALLS WHEN A PRIMARY ANSWERING POSITION IS PERSISTENTLY BUSY

(71) Applicant: WEST CORPORATION, Omaha, NE (US)

(72) Inventors: Stephen Marc Meer, Longmont, CO (US); George Heinrichs, Longmont, CO (US)

(73) Assignee: WEST CORPORATION, Omaha, NE (US)

(21) Appl. No.: 13/681,543

(22) Filed: Nov. 20, 2012

(51) Int. Cl. H04M 3/51

(52) U.S. Cl. CPC H04M 3/5116
USPC 379/45

(57) ABSTRACT

A method for providing continued answering of special number calls intended for delivery via a plurality of communication networks to a primary special number answering position when the primary special number answering position is persistently busy includes: (a) determining at least one pre-identified alternate special number answering position; (b) ascertaining that the primary special number answering position is persistently busy; and (c) directing each routing entity of each respective communication network of the plurality of communication networks to route calls intended for the primary special number answering position to at least one selected alternate special number answering position of the at least one pre-identified alternate special number answering position.

### CROSS REFERENCE TO RELATED APPLICATION

The present application is related to U.S. patent application Ser. No. 12/194,250 entitled “System and Method for Effecting Special Treatment of Emergency Service Calls Originating in a Temporarily Designated Region,” filed 19 Aug. 2008; U.S. patent application Ser. No. 12/553,137 entitled “System and Method for Effecting Special Treatment of Emergency Calls Originating From a Temporarily Designated Region,” filed 3 Sep. 2009; U.S. patent application Ser. No. ______ entitled “System and Method for Providing Continued Answering of Special Number Calls When a Primary Answering Position is Abandoned,” Attorney Docket No. P8520; DDM12-016 filed ______ 2012; and U.S. patent application Ser. No. ______ entitled “System and Method for Providing Continued Answering of Special Number Calls When a Primary Answering Position is Effecting Call Diversion,” Attorney Docket No. P4910; DDM12-017 filed Oct. 3, 2012; all of which are assigned to the current assignee hereof.

### FIELD OF THE INVENTION

The present invention is directed to telecommunication systems, and especially to effecting special routing of emergency service calls routed to a temporarily designated alternate Public Safety Answering Point (PSAP; sometimes referred to as a Public Safety Answering Position) because of an incapacity of a primary PSAP.

### BACKGROUND OF THE INVENTION

A Public Safety Answering Point (PSAP; sometimes referred to as a Public Safety Answering Position) may experience an incapacity, such as by way of example and not by way of limitation, an abandonment of the primary PSAP because of various reasons, an intended diversion from the primary PSAP because of various reasons, the primary PSAP is busy because of various reasons or because of another incapacity of the primary PSAP. In order to provide continuity of response to emergency service request calls, arrangement must be made to assure availability of an answering position to emergency service request calls when a primary PSAP is incapacitated.

Prior art emergency telephone networks include cellular telephone switches connected, sometimes via a Public Switched Telephone Network (PSTN), to a 9-1-1 tandem telephone switch that routed an emergency service call to the correct primary PSAP based upon approximate location of the calling cellular phone. Prior to presenting the call to the 9-1-1 tandem switch, the cellular telephone switch queried a Mobile Positioning Center (MPC) or Gateway Mobile Location Center (GMLC) to obtain a pseudo telephone number that is selected based on the caller's approximate location. The 9-1-1 tandem switch is programmed to route any calls originating from the pseudo telephone number to a particular emergency service answering position or emergency call taking facility such as, by way of example and not by way of limitation, a primary Public Safety Answering Point (PSAP; sometimes referred to as a Public Safety Answering Position). In such a prior art system, the 9-1-1 tandem switch is unable to do anything other than route the call to a predetermined PSAP.

It would be useful if a PSAP call taker or operator could designate one or more alternate PSAP to which alternate routing may be previously established to automatically effect routing emergency calls to the designated alternate PSAPs in a previously predetermined priority order when a primary PSAP is incapacitated.

A primary PSAP may be incapacitated because it has been abandoned. Abandonment of a PSAP may occur, by way of example and not by way of limitation, when the primary PSAP has been destroyed or severely damaged, when communications with the primary PSAP are significantly reduced or disrupted, when insufficient personnel are available to properly staff the primary PSAP or when other circumstances occur which substantially preclude operation of the primary PSAP.

A primary PSAP may be incapacitated because it has experienced a planned service diversion. Said another way, a primary PSAP may be incapacitated because it is effecting call diversion. A planned service diversion (an occasion for effecting call diversion) may result from a service outage such as, by way of example and not by way of limitation, a planned maintenance outage, a planned night service arrangement for another PSAP to receive calls or for another planned occasion for shifting answering responsibilities from a primary PSAP.

A primary PSAP may be incapacitated because it is busy. Such a busy condition may occur because call volume overwhelms the primary PSAP or for another reason requiring that an overflow call routing arrangement is necessary to relieve the primary PSAP of its answering duties. A busy condition may be detected, by way of example and not by way of limitation, when attempts to contact a PSAP are unsuccessful for a predetermined period of time and a busy signal is received, or when attempts to contact a PSAP are unsuccessful for a predetermined number of attempts and a busy signal is received and under other circumstances that indicate the PSAP is not reachable and is busy for a predetermined measured parameter. Such a busy condition that continues sufficiently to cause a rerouting of calls to alternate PSAPs may be referred to as “persistently busy”.

There is a need for a system and method for effecting alternate routing of emergency service calls originally routed to an incapacitated primary PSAP to divert emergency callers to one or more alternate PSAPs in order to assure availability of an answering position to emergency service request calls when a primary PSAP is incapacitated.

### SUMMARY OF THE INVENTION

A system for providing continued answering of emergency service request calls intended for delivery via a plurality of communication networks to a primary emergency service answering position when the primary emergency service answering position is persistently busy includes: (a) at least one pre-identified alternate emergency service answering position coupled with the plurality of communication networks; and (b) a respective at least one routing entity coupled with each respective communication network of the plurality of communication networks; each respective at least one routing entity effecting routing of emergency service request calls intended for the primary emergency service answering position to the primary emergency service answering position when the primary emergency service answering position is operational; each respective at least one routing entity effecting routing of emergency service request calls intended for the primary emergency service answering position to at least one selected alternate emergency service answering position of the at least one pre-identified alternate emergency service answering position when the primary emergency service operating position is persistently busy.

A method for providing continued answering of special number calls intended for delivery via a plurality of communication networks to a primary special number answering position when the primary special number answering position is persistently busy includes: (a) determining at least one pre-identified alternate special number answering position; (b) ascertaining that the primary special number answering position is persistently busy; and (c) directing each routing entity of each respective communication network of the plurality of communication networks to route calls intended for the primary special number answering position to at least one selected alternate special number answering position of the at least one pre-identified alternate special number answering position.

It is, therefore, a feature of the present invention to provide a system and method for effecting alternate routing of emergency service calls originally routed to an incapacitated primary PSAP to divert emergency callers to one or more alternate PSAPs in order to assure availability of an answering position to emergency service request calls when a primary PSAP is incapacitated.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system for effecting the present invention.

FIG. 2 is a flow diagram illustrating the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems and networks, such as commercial marketing or ordering systems, maintenance service networks, college campus security networks and other networks.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

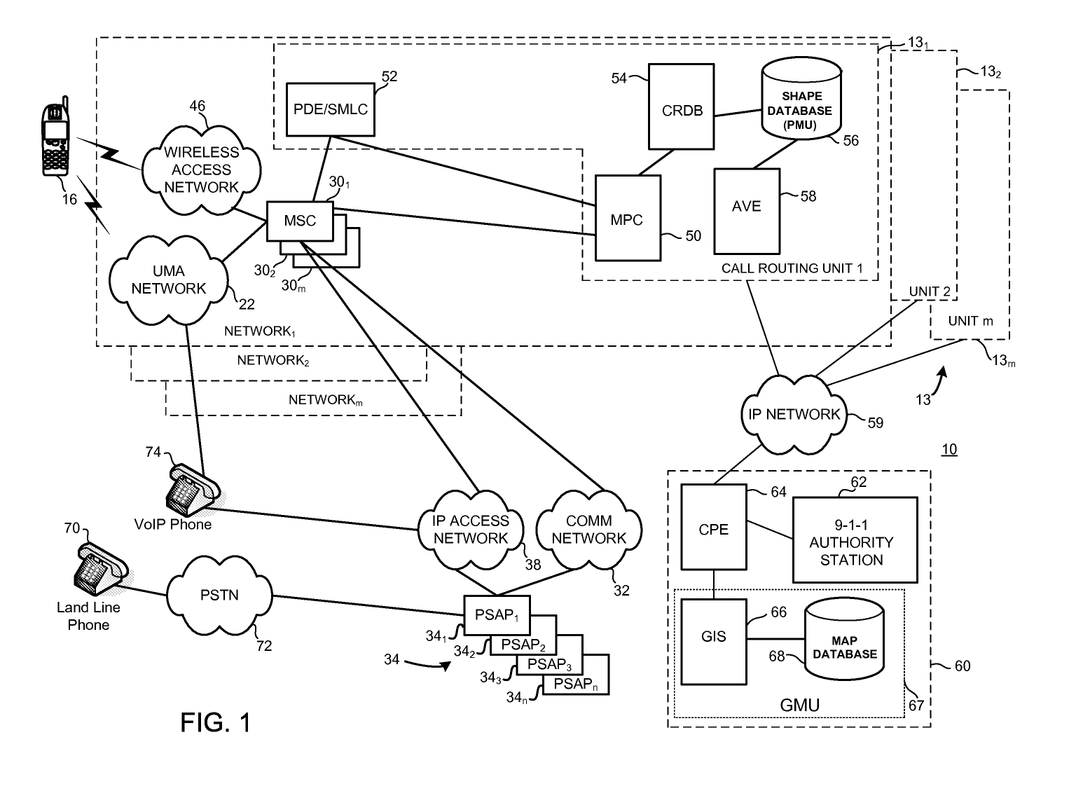

FIG. 1 is a schematic illustration of a system for effecting the present invention. In FIG. 1, a telecommunication system 10 includes a wireless calling unit or instrument 16 configured for effecting communications with a UMA (Unlicensed Mobile Access) Network 22, or a Wireless Access Network 46 or both of UMA Network 22 and Wireless Access Network 46. Wireless calling unit 16 may be embodied in a wireless calling device 16 including, by way of example and not by way of limitation, a mobile telephone, a Personal Digital Assistant (PDA) device, a “Smart” phone, an automatic crash notification (ACN) unit, a mobile radio device or a similar communication device. Wireless calling device 16 may effect communications with one or more network Network₁, Network₂, Networkₘ. The indicator “m” is employed to signify that there can be any number of networks in telecommunication system 10. The inclusion of three networks (Network₁, Network₂, Networkₘ) in FIG. 1 is illustrative only and does not constitute any limitation regarding the number of networks that may be included in the telecommunication system of the present invention. Throughout this description, use of a reference numeral using a generic subscript herein may be taken to mean that any respective member of the plurality of elements having the same reference numeral may be regarded as included in the description. Thus, by way of example and not by way of limitation, referring to Network m in describing FIG. 1 may be taken to mean that any netwwork—Network₁, Network₂ or Networkₘ (FIG. 1)—may be regarded as capable of employment as described. In order to avoid prolixity and cluttering the drawing, only one exemplary network (Network₁) is illustrated in detail in FIG. 1.

UMA Network 22 may be embodied in, by way of example and not by way of limitation, an Internet Protocol (IP) access network. UMA Network 22 may be configured for, by way of further example and not by way of limitation, employment in a Wi-Fi network, a Bluetooth network or another type of UMA (not shown in FIG. 1; understood by those skilled in the art of telecommunication network design). UMA Network 22 may include a link to a Voice over Internet Protocol (VoIP) phone instrument 74.

Wireless Access Network 46 may be embodied in, by way of example and not by way of limitation, one or more of a cellular network or a Personal Communication System (PCS) network employing any of several communication protocols including, by way of further example and not by way of limitation, GSM (Group Speciale Mobile; sometimes referred to as Global System for Mobile communications), Long Term Evolution (LTE), Universal Mobile Telecommunications System (UMTS) or another communication protocol. A communication protocol employed by Wireless Access Network 46 may be one or more of Time Division Multiple Access (TDMA), Code Division Multiple Access (CDMA) or another coding scheme.

Call routing units 13ₘ may be embodied in, by way of example and not by way of limitation, a network accessed using special number dialing, such as 9-1-1.

UMA Network 22 and Wireless Access Network 46 are coupled with a Mobile Switching Center (MSC) 30₁ in Network₁. MSC 30₁ is coupled with a communication network 32. Communication network 32 is coupled with at least one PSAP 34. At least one PSAP 34 may be embodied in PSAPs 34₁, 34₂, 34₃, 34ₙ. The indicator “n” is employed to signify that there can be any number of PSAPs in telecommunication system 10. The inclusion of four PSAPs 34₁, 34₂, 34₃, 34ₙ in FIG. 1 is illustrative only and does not constitute any limitation regarding the number of PSAPs that may be included in the telecommunication system of the present invention. As will be understood by those skilled in the art of telecommunication network design, communication network 32 may be embodied in a plurality of networks; only one exemplary network is illustrated in FIG. 1 in order to avoid cluttering the drawing.

PSAPs 34ₙ may be connected with MSC 30₁ via an IP network 38 to permit communication between PSAP 34ₙ and MSC 30₁without involving communication network 32.

Network₁, Network₂, Networkₘ may each include a respective call routing system 13₁, 13₂, 13ₘ. Each call routing system 13ₘ includes a Mobile Positioning Center (MPC) 50 coupled with a Position Determining Entity/Service Mobile Location Center (PDE/SMLC) 52 and coupled with MSC 30ₘ. In the exemplary Network₁ illustrated in detail in FIG. 1, MPC 50, PDE/SMLC 52 and MSC 30₁ cooperate to ascertain location of a calling unit 16. MPC 50 is also coupled with a Call Routing Data Base (CRDB) 54 to assist in identifying a proper PSAP 34ₙ as a primary emergency service answering position to which emergency calls from the particular location of calling unit 16 are ordinarily routed. CRDB 54 may be coupled with a shape data base 56. Shape data base 56 may be coupled with an Authentication and Validation Engine (AVE) 58. AVE 58, CRDB 54 and Shape database 56 may cooperate to provide the routing instructions to MPC 30₁.

Each AVE 58 in each call routing unit 13ₘ may be coupled with a 9-1-1 Authority Entity 60 via an IP network 59. 9-1-1 Authority entity 60 may include a 9-1-1 Authority Station 62 coupled with Customer Premise Equipment (CPE) 64. CPE 64 may be coupled with IP network 59 and with a Geographic Information System (GIS) 66. GIS 66 may be coupled with a map data base 68.

GIS 66 may be configured to cooperate with map data base 68 to operate as a geographic mapping unit (GMU) 67. Shape data base 56 may be configured to operate as a polygon managing unit (PMU) operated in cooperation with 9-1-1 Authority Station 62 and GMU 67 to aid in designating one or more alternate PSAPs 34ₙ to which emergency service calls should be routed in the event of incapacity of the designated primary PSAP 34ₙ.

A region of responsibility assigned to a primary PSAP 34ₙ may be sub-divided into smaller alternate sub-regions by an authority designating alternate PSAPs 34ₙ. Such sub-dividing may be a useful arrangement when alternate PSAPs 34ₙ are not as fully equipped, not as fully manned, or otherwise not as capable of handling the volume of requests that may have been manageable by the primary PSAP 34ₙ. A sub-divided region may be represented by a polygon on a map display for a user, such as at 9-1-1 Authority Station 62 or at one or more PSAP 34ₙ to aid an operator in visualizing new responsibilities added by designation of a PSAP 34ₙ as an alternate PSAP. One or more of GMU 67, shape data base 56, 9-1-1 Authority Station 62 and CRDB 54 may participate in determining a list of alternate PSAPs 34ₙ in a priority order.

Routing of calls to alternate PSAPs may be based upon any of several parameters including, by way of example and not by way of limitation, geographic origin of a rerouted call, volume of calls rerouted to a particular alternate PSAP and other parameters.

Preferably, once a particular situation has been begun to be handled by a selected alternate PSAP 34ₙ, the situation remains as handled by the selected alternate PSAP 34ₙ even though the primary PSAP 34ₙ may be reinstituted as operational.

As will be understood by one skilled in the art of emergency service network design, 9-1-1 Authority Entity 60 may be embodied in one or more of PSAP 3ₙ, and IP network 59 may be embodied in IP Access Network 38. As will also be understood by one skilled in the art of emergency service network design, each PSAP 34ₙ may include one or more station for manning by an emergency service operation (not shown in detail in FIG. 1). Actions described above in connection with 9-1-1 Authority Station 62 may be performed by an operator occupying any respective station at any respective PSAP 34ₙ that may be appropriately equipped for effecting such actions.

Calling unit 16 may wirelessly access UMA Network 22 to place an emergency 9-1-1 call to establish communication with PSAP 34ₙ via MSC 30₁ and one or both of communication network 32 and IP network 38. Calling unit 16 may wirelessly access UMA Network 22 to place an emergency 9-1-1 call via a VoIP phone instrument 74; or via UMA Network 22, MSC 30ₙ and one or both of communication network 32 and IP network 38.

VoIP phone instrument 74 may be employed to place a call directly to PSAP 34ₙ via IP access network 38; via UMA Network 22, MSC 30₁ and one or both of communication network 32 and IP network 38.

A land line phone instrument 70 may be employed to place an emergency 9-1-1 call to establish communication with PSAP 34ₙ via a Public Switched Telephone Network (PSTN) 72.

Calling unit 16 may instead wirelessly access Wireless Access Network 46 to place an emergency 9-1-1 call with a PSAP 34ₙ via MSC 30ₙ.

Calling unit 16 is capable of communicating in two or more of multiple modes, by way of example and not by way of limitation, via a communication link such as UMA Network 22 or Wireless Access Network 46. Calling unit 16 may access Wireless Access Network 46 to establish communication using any one or more of mode for which calling unit 16 is equipped, such as, by way of example and not by way of limitation, selected of a cellular network or a Personal Communication System (PCS) network employing selected of several communication protocols including, by way of further example and not by way of limitation, GSM (Group Speciale Mobile; sometimes referred to as Global System for Mobile communications), Long Term Evolution (LTE), Universal Mobile Telecommunications System (UMTS) or another communication protocol. Calling unit 16 may be configured for handling telecommunications using selected of Time Division Multiple Access (TDMA), Code Division Multiple Access (CDMA) or another coding scheme. Calling unit 16 may be further configured to communicate using other technologies such as, by way of further example and not by way of limitation, packetized communications such as General Packet Radio Service (GPRS) and text communications using Short Message Service (SMS).

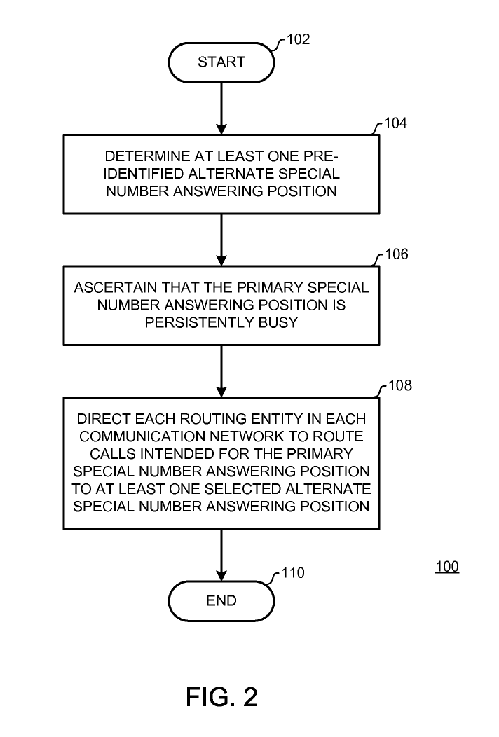

FIG. 2 is a flow diagram illustrating the method of the present invention. In FIG. 2, a method 100 for providing continued answering of special number calls intended for delivery via a plurality of communication networks to a primary special number answering position when the primary special number answering position is persistently busy begins at a START locus 102.

Method 100 continues with determining at least one pre-identified alternate special number answering position, as indicated by a block 104.

Method 100 continues with ascertaining that the primary special number answering position is persistently busy, as indicated by a block 106.

Method 100 continues with directing each routing entity of each respective communication network of the plurality of communication networks to route calls intended for the primary special number answering position to at least one selected alternate special number answering position of the at least one pre-identified alternate special number answering position, as indicated by a block 108.

Method 100 terminates at an END locus 110.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A method for providing continued answering of special number calls intended for delivery via a plurality of communication networks to a special number answering position when a primary special number answering position is persistently busy; the method comprising:
(a) determining that a primary special number answering position is persistently busy by receiving a busy indication for either a predetermined period of time or for a predetermined number of attempts;
(b) determining at least one pre-identified alternate special number answering position; and
(c) directing each routing entity of each respective communication network of said plurality of communication networks to route calls intended for said primary special number answering position to at least one selected alternate special number answering position of said at least one pre-identified alternate special number answering position.

2. The method for providing continued answering of special number calls as recited in claim 1 wherein said primary special number answering position is responsible for a primary assigned geographic area, and wherein said at least one selected alternate special number answering position is a plurality of alternate special number answering positions;
each respective selected alternate special number answering position of said at least one selected alternate special number answering position being responsible for a respective portion of said primary assigned geographic area.

3. The method for providing continued answering of special number calls as recited in claim 1 wherein said plurality of communication networks includes at least one of a Wireless Access Network (WAN), a wireless Unlicensed Mobile Access (UMA) network, a Public Switched Telephone Network (PSTN) and a Voice over Internet Protocol (VoIP) network.

4. The method for providing continued answering of special number calls as recited in claim 1 wherein once handling of a situation relating to a respective special number call is initiated by a selected said alternate special number answering position, the selected alternate special number answering position continues handling the call until the situation is resolved.

5. The method for providing continued answering of special number calls as recited in claim 2 wherein said plurality of communication networks includes at least one of a Wireless Access Network (WAN), a wireless Unlicensed Mobile Access (UMA) network, a Public Switched Telephone Network (PSTN) and a Voice over Internet Protocol (VoIP) network.

6. The method for providing continued answering of special number calls as recited in claim 2 wherein once handling of a situation relating to a respective special number call is initiated by a selected said alternate special number answering position, the selected alternate special number answering position continues handling the call until the situation is resolved.

7. The method for providing continued answering of special number calls as recited in claim 3 wherein once handling of a situation relating to a respective special number call is initiated by a selected said alternate special number answering position, the selected alternate special number answering position continues handling the call until the situation is resolved.

8. A method for providing continued answering of emergency service request calls intended for delivery via a plurality of communication networks to a emergency service answering position when a primary emergency service answering position is persistently busy; the method comprising:
(a) determining that a primary emergency number answering position is persistently busy by receiving a busy indication for either a predetermined period of time or for a predetermined number of attempts;
(b) determining at least one pre-identified alternate emergency number answering position; and
(c) directing each routing entity of each respective communication network of said plurality of communication networks to route calls intended for said primary emergency service answering position to at least one selected alternate emergency service answering position of said at least one pre-identified alternate emergency service answering position.

9. The method for providing continued answering of emergency service request calls as recited in claim 8 wherein said primary emergency service answering position is responsible for a primary assigned geographic area, and wherein said at least one selected alternate emergency service answering position is a plurality of alternate emergency service answering positions; each respective selected alternate emergency service answering position of said at least one selected alternate emergency service answering position being responsible for a respective portion of said primary assigned geographic area.

10. The method for providing continued answering of emergency service request calls as recited in claim 8 wherein said plurality of communication networks includes at least one of a Wireless Access Network (WAN), a wireless Unlicensed Mobile Access (UMA) network, a Public Switched Telephone Network (PSTN) and a Voice over Internet Protocol (VoIP) network.

11. The method for providing continued answering of emergency service request calls as recited in claim 8 wherein once handling of a situation relating to a respective special number call is initiated by a selected said alternate emergency service answering position, the selected alternate emergency service answering position continues handling the call until the situation is resolved.

12. The method for providing continued answering of emergency service request calls as recited in claim 9 wherein said plurality of communication networks includes at least one of a Wireless Access Network (WAN), a wireless Unlicensed Mobile Access (UMA) network, a Public Switched Telephone Network (PSTN) and a Voice over Internet Protocol (VoIP) network.

13. The method for providing continued answering of emergency service request calls as recited in claim 9 wherein once handling of a situation relating to a respective special number call is initiated by a selected said alternate emergency service answering position, the selected alternate emergency service answering position continues handling the call until the situation is resolved.

14. The method for providing continued answering of emergency service request calls as recited in claim 11 wherein once handling of a situation relating to a respective special number call is initiated by a selected said alternate emergency service answering position, the selected alternate emergency service answering position continues handling the call until the situation is resolved.

15. A system for providing continued answering of emergency service request calls intended for delivery via a plurality of communication networks to a emergency service answering position when a primary emergency service answering position is persistently busy; the system comprising:
(a) at least one pre-identified alternate emergency service answering position coupled with said plurality of communication networks; and
(b) a respective at least one routing entity coupled with each respective communication network of said plurality of communication networks; each said respective at least one routing entity effecting routing of emergency service request calls intended for said primary emergency service answering position to at least one selected alternate emergency service answering position of said at least one pre-identified alternate emergency service answering position when said primary emergency service operating position is persistently busy by receiving a busy indication for either a predetermined period of time or for a predetermined number of attempts.

16. The system for providing continued answering of emergency service request calls as recited in claim 15 wherein said primary emergency service answering position is responsible for a primary assigned geographic area, and wherein said at least one selected alternate emergency service answering position is a plurality of alternate emergency service answering positions; each respective selected alternate emergency service answering position of said at least one selected alternate emergency service answering position being responsible for a respective portion of said primary assigned geographic area.

17. The system for providing continued answering of emergency service request calls as recited in claim 15 wherein said plurality of communication networks includes at least one of a Wireless Access Network (WAN), a wireless Unlicensed Mobile Access (UMA) network, a Public Switched Telephone Network (PSTN) and a Voice over Internet Protocol (VoIP) network.

18. The system for providing continued answering of emergency service request calls as recited in claim 15 wherein once handling of a situation relating to a respective special number call is initiated by a selected said alternate emergency service answering position, the selected alternate emergency service answering position continues handling the call until the situation is resolved.

19. The system for providing continued answering of emergency service request calls as recited in claim 16 wherein said plurality of communication networks includes at least one of a Wireless Access Network (WAN), a wireless Unlicensed Mobile Access (UMA) network, a Public Switched Telephone Network (PSTN) and a Voice over Internet Protocol (VoIP) network.

20. The system for providing continued answering of emergency service request calls as recited in claim 16 wherein once handling of a situation relating to a respective special number call is initiated by a selected said alternate emergency service answering position, the selected alternate emergency service answering position continues handling the call until the situation is resolved.
